(19) United States
(12) Patent Application Publication
(10) Pub. No.: US 2005/0114168 A1
(43) Pub. Date: May 26, 2005

(54) Method and system for granting patents

(76) Inventor: Philip M. Goldman, Mendota Heights, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/996,141

(22) Filed: Nov. 23, 2004

Related U.S. Application Data
(63) Continuation of application No. PCT/US03/16523, filed on May 23, 2003.
(60) Provisional application No. 60/382,923, filed on May 23, 2002.

(51) Int. Cl. G06F 17/60

(52) U.S. Cl. 705/1

(57) ABSTRACT

A method and system, including computerized method and system, for determining based on compliance with pre-established criteria. In a preferred embodiment, the method and system are used to determine patentability, or to grant patents, based on an application made by the applicant in which various aspects of the claimed invention are identified and compared to each other and/or to various items of background art.

### CROSS-REFERENCE TO RELATED APPLICATIONS

The present application is a continuation of and claims priority to International Application No. PCT/US03/16523 (published as International Publication No. WO 03/100697), filed 23 May 2003 and designating the United States, which in turn claims priority from provisional application having U.S. Ser. No. 60/382,923, filed 23 May 2002, the entire disclosure of which is incorporated herein by reference.

### TECHNICAL FIELD

The present invention relates to the manner in which awards, such as patent grants, are determined and provided based on completeness and merit in an application. In a related aspect, the invention relates to patents themselves.

### BACKGROUND OF THE INVENTION

Patents have long been granted to reward and stimulate the creativity of inventors. Although they remain an important and valuable tool in this respect, their reputation has been somewhat tarnished over the years, in part because of the delays and inconsistencies that have evolved in the course of granting patents. See, for instance, “The Patent Office faces huge backlogs, extremely technical inventions, and absurd ones”, Teresa Riordan, New York Times, page C2, Monday, May 13, 2002. This article mentions, among other things, the manner in which the “threshold of what is patentable” seems to have fallen significantly from 1952, when it was supposedly the need for a “flash of genius” to today, when it is “merely” nonobviousness.

Most, if not all, systems for determining whether to grant a patent rely on a system of examination that relies on various statutes, rules, administrative decisions and case law governing such concepts as novelty, nonobviousness, and utility. Those rules, in turn, are found in sources that can range from written statutes and rules, to administrative and court decisions, to internal forms and procedures manuals (the Manual of Patent Examining Procedure). These sources provide a maze of ever-increasing complexity for both patent examiners and applicants (including their attorneys and agents) alike.

Aside from the complexity of the rules themselves, the decision of whether to grant a patent is still, to this day, often the result of many critical subjective determinations, and in turn, is vulnerable to the knowledge, skills and potential idiosyncrasies of the individuals involved. It is entirely possible, for instance, that the very same patent claim that is found patentable by one examiner, could, in the hands of another examiner, be conclusively determined unpatentable. In theory, at least, the various educational tools, supervisory roles and appeal processes in place within the patent system are there to minimize the potential for such wide disparities. While the extreme difference between “patent” and “no patent” might be the exception, there is little doubt that considerable differences between examiners (and for that matter, patent practitioners) continue to exist and be reflected in the scope and enforceability of the patents themselves.

Nor are the fundamental reasons for allowing a case often clearly laid out in what becomes the official “file history” for a granted patent. Instead, one is often left to deduce or discern such reasons, to the extent they existed at all, from the correspondence (office actions and responses) that survives. Even here, the prosecution of many applications often includes one or more personal interviews with the Examiner, the results of which are generally summarized in at most a sentence or two for the file. Examination under the Patent Cooperation Treaty is perhaps a bit more fully laid out, if only because the search reports issued in that process themselves identify the cited pieces of art by codes such as “X” and “Y”, for references that are believed to be particularly “close” to the claimed invention, to those in category “A” and others, for references that merely serve as background for the claimed invention. Even more recently, the PCT has implemented a process for streamlined preliminary examination of applications, whereby a “written opinion” regarding patentability would be generated by computer, to mirror the results set forth in the search report (e.g., turning “X” or “Y” references into rejections based on novelty or inventive step).

Still, many, if not all of those who rely on the patent system seek, or expect, a high level of objectivity and predictability, and ideally speed as well. The value of the patent system in continuing to meet its ultimate goals, of stimulating research and rewarding bona fide inventors, seems to also rely on these attributes.

What is needed is a system for reviewing patent applications and granting patents that minimizes the subjective differences that tend to arise, and maximizes the objectiveness and uniformity, speed, openness and predictability of the process itself.

### BRIEF DESCRIPTION OF THE DRAWING

In the Drawing:

FIG. 1 provides an example of a questionnaire for use in eliciting input from an applicant regarding, among other things, both the invention and the cited art.

FIG. 2 provides an example of a decision tree intended to mimic a suitable and objective examination, based on input such as that provided in response to the questionnaire.

### SUMMARY OF THE INVENTION

The present invention provides a method and related system for reviewing patent applications in order to systematically, objectively, and quickly determine whether the applications meets some or all of the requirements for patentability. The system can be used in any suitable form, e.g., as a training tool, as a prescreen for applications, or as a system (or component of a system) for granting patents in its own right. In another aspect, the invention provides a patent, or prescreened application, obtained as a result of the method and system of this invention. In yet another aspect, the invention relates to a questionnaire adapted to elicit answers bearing on the patentability of an invention, and preferably further adapted to download those answers into a computer-based program for determining some or all aspects of patentability, based on the answers derived.

The method and system can be used in other situations as well, and is particularly well suited to those situations in which applications for awards or grants are made, such as patent grants or contract awards, and those applications are evaluated for completeness, merit and compliance with prearranged criteria, by a system that is intended to be as predictable, objective and consistent as possible.

In one preferred embodiment, the system imposes on the patent applicant himself most, if not all, of the task of not only disclosing that invention completely, but also of comparing and contrasting his invention and application with the various requirements for patentability. This would include the need to not only identify relevant “prior art”, but to also then compare the claimed invention with that prior art. These various comparisons are assigned numerical or other suitable relative and/or absolute values, which collectively are assembled (e.g., factored) into a formula (e.g., decision tree) that compares the combined effect of those values with one or more predetermined thresholds determined by the patent office or other appropriate bodies.

In an alternative preferred embodiment, the present invention provides a related method and system for determining infringement, by again assigning one or more identity/proximity or other values between an allegedly infringing device or method and the corresponding claims of the patent at issue. Particularly when the patent itself has been issued, or screened, by the method of this invention, the infringement analysis will be that much simpler and more accurate to perform. Rather than the “threshold” of patentability, such a system or component of a larger system, could be used to determine a threshold of infringement akin to today's determination of infringement in either literal terms (e.g., akin to “novelty” in determining patentability) or under the “doctrine of equivalents”. Where, as currently is the case, that Doctrine is determined to be narrow (as by the “Festo” decision), the corresponding threshold value(s) in the infringement analysis can be suitably modified as well. An internal opinion regarding infringement or invalidity, therefore, could be crafted and arranged in such a way as to make its findings subject to easy review by a court or others. If desired, the threshold for determining patentability can be set somewhat “lower” than that required to invalidated the corresponding patent, in order to approximate the “presumption” of validity currently accorded an issued patent.

The identity and proximity indicators of the present method can be of any suitable form and be used in any suitable manner. In one preferred embodiment described below, this can involve a weighting or other affirmation of the extent to which one element suggests another. In another preferred embodiment described below, this can involve a determination (preferably by the applicant himself) of whether a particular element or combination of elements is “patentably distinct” from another, or that it “teaches or suggests” the other. That other element can be either one within the specification itself, as in the comparison of one claimed species to another or a species to its genus, or it can be in the cited art.

In a particularly preferred embodiment, therefore, the present invention provides a method for reviewing a patent application disclosing an invention in order to determine the extent to which the application meets some or all of the requirements for patentability, in view of one or more cited prior art references, the method comprising the steps of:
a) eliciting input regarding the invention, in order to establish one or more elements of the invention described in the application and the relationship between those elements and each other, combinations of such elements, and/or the cited art,
b) analyzing the elicited input in a semi- or fully automated fashion in order to determine whether one or more claims of the application, comprising one or more of its elements, meets predetermined standards for patentability.

More preferably, some or all of the input is provided by the applicant and in response to a questionnaire, by means of which the input is elicited in order to establish some or all of the elements in a hierarchal relationship with respect to each other, for instance, a genus-species-subspecies relationship for one or more elements. The input can be analyzed using any suitable means, including by artificial intelligence (an expert system or neural network), or by applying it to one or more decision trees. Those skilled in the appropriate art, given the teaching of the present invention, will be able to develop such systems and provide them in conventional forms of rules, documentation and software, such as JAVA or C++.

In such an embodiment, for instance, the input includes the identity of one or more cited art references, and the relationships between one or more elements or combination of elements of the invention and the teachings of the cited art and/or between the teachings of the references themselves, and more preferably, the relationships include an affirmation regarding the extent to which the applicant considers a genus, species, and/or subspecies of a described element or combination of elements to be patentably distinct from each other, and/or from the genus, species, and/or subspecies of another element or combination of elements, and/or from the teachings of the cited art.

It should be noted that the present system is not intended to itself search the prior art, or to automatically provide comparisons between that art and the disclosed invention. Efforts along both lines are proceeding by others and would be facilitated but not replaced by the method presently described. Nor, in turn, is it necessary that each applicant define their inventions or various elements in either terms, or within a hierarchy that is consistent with other inventors, or with the prior art. Instead, so long as the applicant's description and relationships are consistently established and applied, the end result will be the same and acceptable for all. In other words, were one inventor to consider his invention to include elements A+B+C+D, while another would describe and consider that very same invention include merely the combination of A+E (where, in essence E is the sum total of B+C+D), the analyses carried out by each would be identical so long as they both remain internally consistent, assuming they consider the cited art in a similar fashion and establish the same relationships with that art.

Preferably also, the method is adapted to be modified in accordance with changes in the law and/or jurisdictional or cultural differences regarding patentability, and/or further comprises eliciting input to assess the manner and/or extent to which the application complies with one or more other requirements, selected from the group consisting of those commonly known as best mode, written description, and enablement.

In use, for instance, the method can be performed by accessing a suitably secure site made available on the internet, either on a commercial site, private or not-for-profit site, and/or a government hosted site. Such as system comprises automated means for eliciting and analyzing the input.

In other embodiments, the present invention provides a patent or prescreened application obtained as a result of the performing the method of any preceding claim; a method of analyzing a granted patent in order to assess its validity, the method comprising applying a method as described herein to the granted patent. Perhaps most preferably, the granted patent under review is itself one that was granted using the method of this invention, and the method of assessing its validity comprises the step of repeating the analysis, changing one or input parameters, in order to assess the impact of such change on patentability. In yet another embodiment, the present invention provides a questionnaire and decision tree adapted for use in the method of any preceding claim.

### DETAILED DESCRIPTION

In this manner, the various input and values that the applicant or others ascribe to various parameters can be maintained in the file and therefore open to individual scrutiny, either by the applicant himself, the patent office, or by those seeking to invalidate the patent at a later date. For instance, an applicant that identifies a particular reference as teaching an element that is only remotely similar to his own, may well be issued a patent, but might jeopardize either the initial patentability or certainly the long term enforceability of that patent, if it can be shown that, in fact, the particular reference is considerably “closer” to his element than he thought. At the very least, review of the basis upon which patentability was determined can be facilitated significantly.

On the other hand, prior to actually filing his application, such an applicant might unilaterally propose claims of varying style and scope (in either discoverable or nondiscoverable form), to the point where only those that are patentable can be identified. At that time, he or she could determine whether those “allowable” claims of sufficient scope to undergo the next steps (including application, publication and costs) of issuing his patent. A typical submission could include an array of claim styles and scope, as is currently done, together with a completed questionnaire or other suitable form which would immediately be returned with an assessment of those that exceed one or more thresholds, and perhaps the extent to which they do.

Similarly, one challenging the patent might be able to determine with precision just how “close” a new reference must be, if found, in order to justify the invalidity of the issued patent. The challenger could also determine with considerable certainty, which of the answers provided by the applicant, if challenged successfully, would change the outcome regarding patentability. Assuming various parameters or thresholds happen to be changed by the Patent and Trademark Office (“PTO”) or courts over time, it would a relatively simple matter of rule making and case law to assess whether the values to be used by one challenging the patent should be those in effect as of the date of filing the initial application, its date of issuance, the period of its litigation, or some other time or times altogether.

Rather than the present process, in which the basis for the ultimate decision regarding patentability is often incomplete, complex or diffuse, if discernable or available at all from the file, the present system would break that decision down to elements that are clearly stated on the record, and subject to appropriate and individual review. It is entirely possible that both the threshold and the method of coalescing the individual data points could either be kept secret by the patent office, and/or could be modified by the PTO as desired, to ensure that only those patents issue that are deemed sufficiently worthy. Similarly, the system is amenable to other options not yet part of the patent system, including to provide different levels or forms of patents (e.g., utility patents, utility models, design patents, etc.) corresponding to different thresholds having been met. In turn, the term or other features associated with any such award could be modified as well, to correspond with whatever thresholds or parameters the PTO may choose.

In one preferred embodiment, the requirements for patentability are selected from the group consisting of novelty (identity with the prior art) and nonobviousness or “inventive step” (similarities and dissimilarities as compared to the art). Optionally, the requirements can include one or more of the other several requirements imposed on a patent application, including compliance with the written description, enablement, and best mode requirements, or for clarity, and the like.

In a particularly preferred embodiment, the system and method can be accomplished without the need for professional assistance, e.g., by the use of a carefully worded questionnaire that elicits certain information from the applicant regarding the elements of his invention and those of each piece of prior art—all in a manner and for a purpose that could be kept largely invisible to the user, and hence, difficult to second guess or fool. That questionnaire, and some or all components of the system itself, can be suitably designed and controlled to provide the requisite levels of confidentiality and security to encourage its use.

In practice, the system can accelerate the patent preparation, application, prosecution, and/or issuance processes considerably. The time involved in the patent examination process can be shortened from the current process, which can take several years to complete, to one that could be achieved with weeks, days or even hours. Rather than file a patent application and remain for years in the “patent pending” mode, during which time the application is likely to be published with no promise of a patent, applicants (and potentially others, including competitors and investors) would know almost instantly whether a patent will (or is likely to) issue, and the specific scope of that patent.

In addition to its potential use within a patent office itself, as a tool for reviewing and granting patents, the system can be used instead, or in addition, as a prescreening tool, to permit the applicant to better judge the merits of his or her invention. In one embodiment, for instance, the system can be used to grant patents in an ex parte mode, and without the need for examiners at all (or using examiners in a reduced or different (e.g., compliance, quality assurance or supervisory) role). Even if implemented, the Patent Office would likely remain a vital part of the process, e.g., by continually improving, amending and implementing the system, and/or by auditing occasional applications and serving as a resource for the applicants, in a manner analogous to the Internal Revenue Service on tax matters. Even without direct examiner involvement, the integrity of the system is maintained, if not actually improved, in a number of ways, including: 1) by virtue of the already high (and potentially higher) duties of candor imposed on the applicants themselves, 2) by the prospect for audit within the PTO, and perhaps most ominously, 3) by the potential for review and scrutiny (and potential repercussions) in the course of later inter partes proceedings, whether by means of arbitration, opposition, interference, reexamination, reissue, or litigation.

In one such preferred embodiment, an ex parte process would simply leverage and build upon several steps that tend to already be performed by the applicant. These include the need to carefully prepare and file an application, to craft an assortment of claims of varying categories, scopes and combinations, and to identify whatever relevant prior art he or she may be aware of. In order to avail him or herself of the method of this invention, it would not be unduly burdensome for the applicant and/or examiner to go one step further, in order to attribute identity and similarity/dissimilarity values (including in the form of verbal relationships, such as one element or reference “teaching or suggesting” another), between the elements of the claimed invention and the teachings of the prior art. With those values in place, the decision regarding patentability can be submitted to a program suitably adapted to perform the method described herein. Those skilled in the art of software design, given the present intent and teaching, would be quite capable of designing one or more programs adapted to provide the desired results.

Such a program will typically identify the manner in which the limitations set forth in various claims meet a predetermined threshold for patentability, in a manner analogous to that done by Examiners today. Assuming one or more claims are determined to be patentable, the applicant may either accept the grant of a patent to include those claims, or can review and reassess the prior art, and in turn, the similarity values previously assigned.

The threshold determination of allowable vs. nonallowable claims, as well as the criteria addressed in the questionnaire, the weight to be given to each criteria, and to the scaling or gradation of responses within each criteria can all be modified as desired by the PTO in order to accomplish desired effects and address changes in the law. In one preferred embodiment, the applicant's input is applied to one or more decision tree analyses, the paths of which conform to accepted standards of review.

Optionally, the applicant may appeal or seek review of the patentability threshold itself. In one optional embodiment, if permitted by the laws of any particular jurisdiction, one or more other variables may be included into the system, e.g., the ability to vary the patent term itself in accordance with the extent to which one or more thresholds are met or exceeded. By way of example, a combination of elements that fails to meet a predefined threshold for nonobviousness may nonetheless be granted as a patent if it meets a somewhat lower threshold, in exchange for a correspondingly limited term or geographic scope. Such a system may have particular application in those patents systems that provide for inventor's certificates and the like.

To the extent permitted by other applicable laws and practices, the system can also, or instead, be used within a consortia of applicants, such as within a defined industry group, to create and allocate protectable positions as amongst its members, quickly, far more predictably and cost-effectively, and based on uniform and agreed upon criteria.

In another embodiment, the invention provides a computerized method of determining patentability and/or granting a patent, comprising the steps of:
a. receiving one or more identifier corresponding, respectively, to one or more claim limitations;
b. receiving one or more identifier corresponding, respectively, to one or more items of background art;
c. receiving at least one set of proximity indicators which correspond to the relationship between one or more limitations (e.g., “identical”, “patentably indistinct” or “patentably distinct”), or combinations thereof, and one or more items of prior art, or combinations thereof;
d. storing the limitation identifiers, the prior art identifiers, and the proximity indicators on a computer readable medium;
e. receiving an initial determination as to the manner in which one or more limitations or combinations thereof are considered novel and/or nonobvious as compared to one or more items of prior art or combinations thereof;
f. receiving an initial determination as to the manner and/or extent to which a plurality of prior art references are considered to be capable of combination, based on applicable patent law principles,
g. establishing a patentability threshold analogous to the “flash of genius”, unexpected results, or other desired threshold for determining inventiveness over the art; and
h. using the initial determinations provided in steps e and/or f to determine whether a patent should issue based on a particular limitation or combination of limitations, and as compared to one or more items of prior art, and to the degree established by the threshold.

The present invention provides a method and system for granting patents, in one preferred embodiment, the method comprising the steps of:
a) determining one or more individual elements of the claimed invention
b) determining one or more combinations of the elements determined in step a),
c) reviewing the relevant, known items of prior art in order to assign a qualitative or quantitative comparative value for each element and/or combination of elements, based on the extent to which the individual items of prior art can be shown to teach or suggest the particular elements and/or combinations,
d) statistically determining the novelty and nonobviousness of each element and/or combination, as compared to individual or combined items of prior art, using an algorithm designed to compare and/or weigh the comparative values assigned in step c)
e) determining one or more threshold values above, or by comparison to, which a patent will be granted,
f) comparing the statistical value(s) determined in step d) with the threshold value(s) of step e) in order to determine whether a patent should be granted as to any particular claim or claims.

In practice, the patent applicant, working with his or her agent or attorney, can identify the elements and combinations (steps (a) and (b) above), in a manner analogous to current methods of patent drafting and claiming. The patent applicant, either on his/her own or together with the Examiner, can then review the prior art of record in order to come to agreement on the comparative value of step (c). Thereafter, the computerized system of this invention determines the various calculations called for above, in order the determine the extent to which a patent might be granted. It can be seen that most subjectivity is avoided in this manner, or is at least broken up into smaller components that are subject to review and revision.

The applicant will also work with his attorney or agent to both search the literature and to determine those items that actually rise to the level of “prior art”. Instead, or in addition, the system of this invention can include a function that will determine whether, and the extent to which, any particular item will indeed be considered as “prior art” against the claimed invention, based on the corresponding dates of publication, filing, etc. Typically, the applicant would not want to concede that a particular reference is prior art, when indeed it may not be, particularly if it meant then providing comparisons between the claimed invention and that reference in discoverable form. On the other hand, applicants could, if carefully guided, choose to distinguish their inventions over references that may not themselves be considered prior art, if to do so might further enhance their position with respect to as yet undiscovered art of a similar nature.

By way of example, consider the situation in which a watering can is claimed, having a pout and water inlet in combination with an optional handle, optional lid over the water inlet, nd optional screen within the spout. In this example, both the spout and handle can independently assume different configurations or shapes, dimensions, etc.

Using the method of the present invention, a questionnaire could be generated to elicit the following breakdown of elements and features, together with an assessment of the proximity of those features with various known items of prior art. In parenthesis below are shown the qualitative and/or quantitative values assigned to such matters, in this case, with +++ meaning that a feature is not taught or suggested at all in a reference, to − meaning that the feature is identical, or substantially identical to one described in the reference.

A—Liquid Carrying Can

not present at all in reference X (+++)
present but significantly different to the point where Rx “teaches away” (++)
other element present that could be modified to provide element (+)
broader than claimed element, though could include claimed element (0)
substantially the same as element of the invention (−−)
   B—Emptying Means
not present at all (+++)
present but significantly different to the point where it “teaches away” (++)
broader than claimed element, though could include claimed element (0)
substantially the same as element of the invention (−−)
   B1—Spout
not present at all (+++)
present but significantly different to the point where it “teaches away” (++)
broader than claimed element, though could include claimed element (0)
substantially the same as element of the invention (−−)
   C—Handle
not present at all (+++)
present but significantly different to the point where it “teaches away” (++)
broader than claimed element, though could include claimed element (0)
substantially the same as element of the invention (−−)
   C1—Straight Handle
not present at all (+++)
present but significantly different to the point where it “teaches away” (++)
broader than claimed element, though could include claimed element (0)
substantially the same as element of the invention (−−)
   C2—Curved Handle
not present at all (+++)
present but significantly different to the point where it “teaches away” (++)
broader than claimed element, though could include claimed element (0)
substantially the same as element of the invention (−−)
C2a—curved handle 6-12 inches long
C2b—curved handle 7-11 inches long
C2c—curved handle 8-10 inches long

Similar questions and answers could be generated for the various “dependent” claims and related optional features of the structure, for instance, including:

D—Screen

D1—integral with spout
D2—separately inserted
   E—Lid/Cover
E1—generally
E2—flip type
E3—screw or other (non-flip) type

The novelty analysis for any particular claim can be quite straightforward to the point of not even requiring a computer, for instance, searching for any combination in which the response elicits one or more +'s for each element included within a particular claim.

The obviousness analysis for any particular claim will ensue only in the event novelty is found, and will depend on a comparison of the various references, for instance, comparing the various responses in order to first provide a combination having at least a 0 or + in each category, and then comparing (or factoring in a comparison of) the likelihood of combining the various references involved (which would be discerned from other portions of the same or different questionnaire). The questionnaire would elicit the information in the form of as many small, specific bits of information as possible, with each questions phrased as objectively as possible (in synch with the pertinent law or rule). As known to those skilled in the art, the proper phrasing and construction of an effective questionnaire is itself a task best left to those experienced in such things.

In terms of comparing the references themselves, both with the invention and with each other, the application could be asked to considers to be the “closest” 5 or 10 references (since the determination of patentability rarely requires close consideration of more than this number), and for each provide the following comparisons and “relationship” (R) values:

R¹—Reference Questionnaire

different industry as invention and no relationship with invention (++)
different industry as invention though potential overlap invention (+)
same industry as invention but including others as well (−)
same specifically industry/application as invention (−−)
relationship with other references
   R¹ and R² physically combinable
      combination suggested by one or the other for the same purpose
      combination suggested for another purpose than the invention
      combination not suggested
      combination specifically taught against
   not physically combinable
   R¹ and R² same art area as each other

It is entirely possible, for instance, that the combination of two references might provide all of the elements of a particular claim, yet the combination is found nonobvious and allowable because the particular references score very poorly on the “combinability” index. Similarly, the software can be designed to accommodate any other features of current practice, e.g., the current practice against the use of “multiple references” can be accommodated simply by imploring statistical methods to show the decreased likelihood of combining more and more references.

The loss of personal input by an examiner is more than made up for by the consistency and reviewability of the ultimate decision. A third party, judge or jury can independently review and “second guess” the scores provided by the applicant.

Those reviewing the patent, whether potential infringers, judges or juries, will benefit as well, since they will have a much better perspective of the decision making process.

A typical mechanical invention might include parts A+B+C+D+E (e.g., a watering can (A) having a particular type of handle (B) and particular spout (C), as well as a screening device (D) that can be inserted within the spout and a lid (E) that can be positioned over the opening of the can.

The patent applicant may determine that parts D and E are preferred, but optional, both in terms of the device itself, and in terms of what he perceives as the prior art, i.e., he finds no other similar watering cans having such handles and spout combinations, with or without the screen or lid. He may therefore consider the essence of patentability to reside in the combination of A+B+C. Even though he, himself, intends to market a device with all five components, if at all possible, he would like to prevent others from directly competing with him just because they avoid the use of a screen and/or lid.

In current practice, the applicant goes into Patent Office thinking he deserves, and would like a patent as broad as just A+B+C, but he realizes that he would be satisfied, if need be, with one that claims only A+B+C+D (but no narrower, that is, for whatever reason, he would not be willing to include E as a necessary part of the broadest claim, unless absolutely necessary in view of the art). Note, in turn, that each part or element can take different forms or species, e.g. C1, C2, C3 could refer to a straight spout, curved spout and spiral spout, respectively. These species, in turn, could be provided in one or more narrowing or independent subspecies (e.g., C1a, C1b, C1c could be straight spouts having lengths between 6-12 inches, 1-11 inches or 8-10 inches, respectively).

The application would be filed with an array of claims, such as:
1. A watering can comprising parts A+B+C
2. The can of claim 1 further comprising part D (essentially read as a claim to A+B+C+D)
3. The can of claim 1 further comprising part E (A+B+C+E)
4. The can of claim 2 further comprising part E (A+B+C+D+E)
5. The can of claim 1 wherein the spout C is straight. (A+B+C1)
6. The can of claim 1 wherein the handle B is either rounded or oval in shape (A+B1 or B2+C).
7. The can of claim 4 wherein the spout is straight and the handle is either rounded or oval in shape and 7 to 10 inches long (read as A+B1 or B2+C1c+D+E).

Assume that the prior art, found by either the applicant or the examiner, is of the following types:
R¹ A+E (same type of can with entirely different spout and handle, no screen, but same lid)
R² B+C (a gas can having the same type of handle and spout)
R³ A+B+C2 (watering can, handle, though disclosing only a curved spout)
R⁴ A+B+D (a watering can with handle and lid, but with a drainage tube rather than spout)

In one embodiment of the present invention, the applicant and/or the examiner, and preferably both review the application and claims in order to identify these component parts or steps. They then establish, and ideally come to agreement as to, the relationship between the identified components and the prior art, in order to attribute “proximity” or “identity” values to the varying references and to corresponding elements. The related data is entered into a suitable program in order to compare the various values in a manner sufficient to determine whether the similarities and dissimilarities are of sufficient magnitude to warrant the granting of patent thereon. The analysis can be made on the basis of the claims presented by the applicant and/or on the basis of the program itself seeking out combinations within the description.

The system of this invention can be used to compare the combined elements for purposes of both novelty, e.g., identifying those item(s) of prior art that include each of the elements set forth within a particular claim, and for obviousness and utility. The program also compares each combination of elements for purposes of nonobviousness, or inventive step, to compare them to a predefined threshold for nonobviousness. The threshold can be different for different industries, could be changed over time (analogous to a casino changing its slot machine payout), if too many, or overly broad, patents appear to be issuing, and so on.

In a further, and preferred embodiment, the manual (and in turn, subjective) aspects of the process are further minimized to the extent desired, e.g., by permitting the program itself to seek and identify items in the prior art. This will require both access to such prior art, and the software sufficient to search and cull that art in order to find similarities therein. Automated searching can be expedited based on common authors, assignees, key words, classification codes and the like.

The net result is not only a more predictable, methodical and objective system, but also one in which the basis for the patent grant would be readily apparent and reviewable. Then, for instance, if a later challenge were ever made to invalidate the patent, on the basis of newly discovered prior art that was not previously cited but is closer than that which was (key requirements of any such reference), the court could readily determine whether in fact it is new and uncited, if so, they could determine the extent to which it is closer, and finally, compute the same equation using the then-existing threshold (or other suitable threshold) to determine whether a patent would and should have been granted.

In an alternative embodiment, the “threshold” of patentability with regard to any particular claim is determined by applying the applicant's input to one or more decision tree analyses designed to mimic the examination process.

The present system can be used to mimic, supplement or support, or replace entirely the current role of Examiners in the course of patent examination. It would have no necessary or immediate impact on other aspects or activities of the Patent and Trademark Office, including those relating to search procedures, fees, or appeal or enforcement, though it is certainly conducive to being integrated with those and other systems as time goes by, and particularly as a system of the present invention becomes implemented and accepted in practice. Acceptance of such a system should be facilitated in that it mimics not only the examination process itself, but also follows the precedent provided by well established rules of patent examination, such as those regarding expedited examination.

It is currently and commonly the case, for instance, that among the various ways an applicant might seek expedited examination in the US, would be to provide the Patent Office with a prescribed search and to compare, on the record, the claimed invention with the results of that search. The system of the present invention follows in that lead by making the entire process far more open, complete, automated, reviewable, and expedited.

It is also the case that the patent offices of the world are heading toward an era where acceptable searches will be performed in a variety of ways and from a variety of sources, including contract sources. A system of the present invention could be employed at any suitable time, and ideally after the applicant has received and carefully considered a search report that will be acceptable to the patent office of choice.

In turn, the current system is not designed to alter either the law or processes regarding patentability or examination, and instead takes pains to adapt itself to those current practices, in order to facilitate its use and acceptance. The system has the potential, however, to provide new and different opportunities and approaches, for integrating the preparation, searching, examination, issuance, challenge and/or enforcement of patents on inventions.

Whatever concern there may be that an applicant may attempt to circumvent the system, as by incorrect answers or withholding vital information, is more than compensated by both the ethical obligations, and corresponding penalties, that applicants will continue to bear, and by the fact that the entire process has the potential to be reviewed and revisited. In the event a single input can be challenged, and would affect the patentability of a corresponding claim, any attempt to circumvent the system would be fruitless, and be done at the applicant's peril.

In use, for instance, upon receipt and review of a suitable search report by an applicant (or perhaps even before that point, using informal search results of his/her own), the applicant would be able to access the current system in a web-enabled form, and immediately determine whether a patent should or will be issued, based entirely on his/her own inputs and answers to a variety of questions. While a “self service” approach to examination of this type might raise suspicions, any such concerns are more than balanced by the combination of the ethical duties already placed on an applicant, and the speed, predictability, and reviewability of the corresponding examination process. Add into this the likelihood that an applicant and attorney or agent, working together, will be as—or possibly far better—able to make the various determinations called for than an Examiner who might be new to the case and perhaps under pressures of time and performance.

Objectivity and honesty is also ensured by the fact that every input and corresponding assertion or affirmation made by the applicant will be stored and available and subject to later review and scrutiny, by an Examiner, court, or third party. Any input that seems questionable or subject to challenge can be rerun with a different input or answer, to determine whether such a difference would have prevented patentability. If so, that later reviewer would know precisely where and how to focus his/her further efforts.

The current system will permit applicants to assess patentability essentially immediately, thereby dramatically improving the extent to which they can proceed with the variety of other important activities that can often depend on patent protection, including to foreign file the application, to solicit investors, to predict and establish a marketing plan based on patent exclusivity, and to generally build their product or business on the firm foundation of confirmed patent rights. In turn, the claimed system can alleviate the uncertainty inherent in the current, Examiner-based, examination process, in which the time from application to grant can take years, and unfortunately, is considerably less predictable or consistent.

The examination system includes the following components:

1) Information and Data Input

Applicant accesses or inputs the entire application, and relevant data, as by conventional electronic filing. Optionally, the applicant can proceed directly to the current program, where the various prompts and answers are themselves used as, or to prepare, a corresponding application. Also input are the Search Report data and findings (individual references become R1, R2, etc).

2) Questionnaire

The questionnaire is intended to accomplish the following:
a) To rigorously elicit and organize each of the various elements of the invention into a comprehensive genus-species-subspecies relationship.
b) To call for the applicant to then establish comparative relationships between the various elements themselves, between references themselves, and between elements and references, for instance, i) the extent to which any particular element teaches or suggests another, ii) the extent to which one reference teaches or suggests an element or combination of elements, and iii) the extent to which one reference is capable of being combined with another, and with the field of the invention itself.
c) To elicit the applicant's assurance that the various other requirements are met, including the “how to make” and “how to use” requirements, best mode, enablement, and so on. The applicant is asked to affirm, under oath, that the essential criteria for each requirement are met, and to identify for the record the particular portion or portions of the specification that apply.
d) Optionally, to go above and beyond current practice by requiring the applicant to affirm, step by step, that a variety of other aspects affecting the patentability, validity, or enforceability of the patent are met, e.g., by individually addressing the various elements of the oath/declaration (e.g., asking when, if at all, the subject matter of any particular embodiment of this invention was first offered for sale or placed in public use, etc. An affirmative answer to any such question could lead to further inquiry regarding precisely what was offered or publicly used, and when, converting the data provided in these answers into yet another Reference, if applicable.

Answers to questions (e.g., identifying elements) must correspond with specification to the extent necessary, e.g., an element cannot be included in an answer (or in turn a claim) unless the system finds literal antecedent basis in the specification (or nonliteral with appropriate caveats).

3) Determination of Patentability

Upon the input of the data, and completion of the Questionnaire, the system employs a decision tree, unique to the rules and practices of the particular jurisdiction, to determine whether any particular claimed combination of those elements is patentable. The system can analyze the particular claims offered by the applicant, or it can easily analyze all possible combinations of those elements to determine those combinations that would be patentable, given the applicant's input. Similarly, the system can lock in on or more preferred elements, in order to determine what other combinations of elements may be necessary to provide protection around the preferred element.

4) Pre- or Post-Issuance Challenge

A potential infringer can challenge the grant of the patent by accessing and evaluating the entire input generated by the applicant in the course of obtaining his patent, and determining whether any particular determination might affect the patentability of relevant claims, if changed to a different or opposite answer. In so doing, the challenge can immediately be focused on those particular questions of fact or law that are clearly shown to have played a pivotal role in patentability, thereby reducing the cost, time, and uncertainty of litigation to a mere administrative proceeding. The presumption of validity can continue to apply, if at all, to those instances in which a particular determination is considered a close call.

The interaction between a review process of the present invention and the current activities of the USPTO can take any suitable form, including: a) the current process stands outside PTO, as a self test and training tool for applicants (and/or for use by Patent Offices in jurisdictions without their own examination capabilities); b) the results of a review performed by the current process are accepted as a basis for expedited examination within PTO; c) a review performed by the current process is offered as an option to traditional examination to applicants, and d) the current review replaces some or all forms of traditional examination entirely, perhaps on a case by case basis, or by art unit, or invention type.

### EXAMPLE

An “automated” examination can be performed for a hypothetical invention in which a new “combination” is made of a car having a radio in the dashboard and an antennae on the hood. Prompted by a questionnaire of this invention, such and invention could be broken down into the combination of elements A+B+C, where:
A=a vehicle, such as a car
B=receiving device, such as an AM/FM radio, preferably in the dashboard
C=antennae, especially within windshield
   Optionally also including D=separate TV monitor

Note that it is not critical the applicant categorize and order his/her elements in a manner that is consistent with the art, or with any other applicant or application, including his/her other applications. It is important, however, that the applicant be internally consistent, for instance, in order to ensure that he/she compares “apples to apples”, by having genus/species relationships that are internally accurate and consistent. If, for instance, a different applicant were to identify the invention as having merely two components, such as car/radio with an antennae, and even if he/she used terms for those components that were quite different from those used in the art, the fact that the applicant would apply those consistently, including to the cited prior art, would mean that the same essential relationships, and corresponding decisions would be reached.

In turn, the system would prompt the applicant to identify a hierarchy regarding each element, in order to and to compare “prior art” categories: In this case, an example of such a hierarchy would be as follows:
A.0—vehicles generally
   A.1—road vehicles
      A.1.1—taxi
      A.1.2—commercial truck
      A.1.3—selected from group (passenger car, van, truck)
         A.1.3.1—cars
         A.1.3.2—vans
         A.1.3.3—trucks
   A.2—planes
      A.1.1—private planes
      A.1.2—commercial planes
   A.3—trains
   A.4—boats
B.0—receiving devices
   B.1—radios
      B.1.1—positioned in dash
         B.1.1.1 AM only
         B.1.1.2 AM/FM
         B.1.1.3 AM/FM/cassette
      B.1.2—positioned under dash
      B.1.3—positioned elsewhere
   B.2—CB's (citizens band device)
   B.3—GPS (global positioning device)
C.0—antennas
   C. 1—integral with radio
   C.2—connected by wiring
      C.2.1—roof antennae
      C.2.2—TV rabbit ears
      C.2.3—on hood or fender
      C.2.4—in windshield
   C.3—wireless

Once established, these various elements and hierarchy can be used to generate claims, either by the applicant, by the Patent Office, or automatically by the system itself.

Sample Claims:

1. A.0+B.0+C.0 (i.e., vehicle+receiving device+antennae)
2. (1)+D.0 (i.e., all from 1+TV)
3. (1)+A=A.1-4 (where vehicle is road, plane, train, or boat)
4. (3)+A=A1.3 (where road vehicle is a car, van, or truck)
5. (4)+A1.3.1 (where it's a car)
6. (1)+B=1.1-3 (radios, CB's, GPS)
7. (6)+B=B. 1 (radios)
8. (7)+B. 1.1-3 (in dash, under dash, other)
9. (1)+C=C.1-3 (antennae integral, wired, or wireless)
10. (9)+C=C.2
11. (3)+B=1.1-3 (radios, CB's, GPS)
12. (11)+B=B.1 (radios)
13. (12)+B.1.1-3 (in dash, under dash, other)
14. (13)+C=C.1-3 (integ, wired, unconnected)
15. (14)+C=C.2
16. A.1+B.1+C.1
etc.
20. A1.3.1+B1.1.1-3+C.2
   Other exemplary claims, in different categories, include:
21. Method of making a combination of claim 1
   provide A, B, C
   mount B onto A
   mount C onto A
   connect B and C
31. Method of using a combination of claim 1
   provide A+B+C
   turn on B
   employ C to provide improved reception

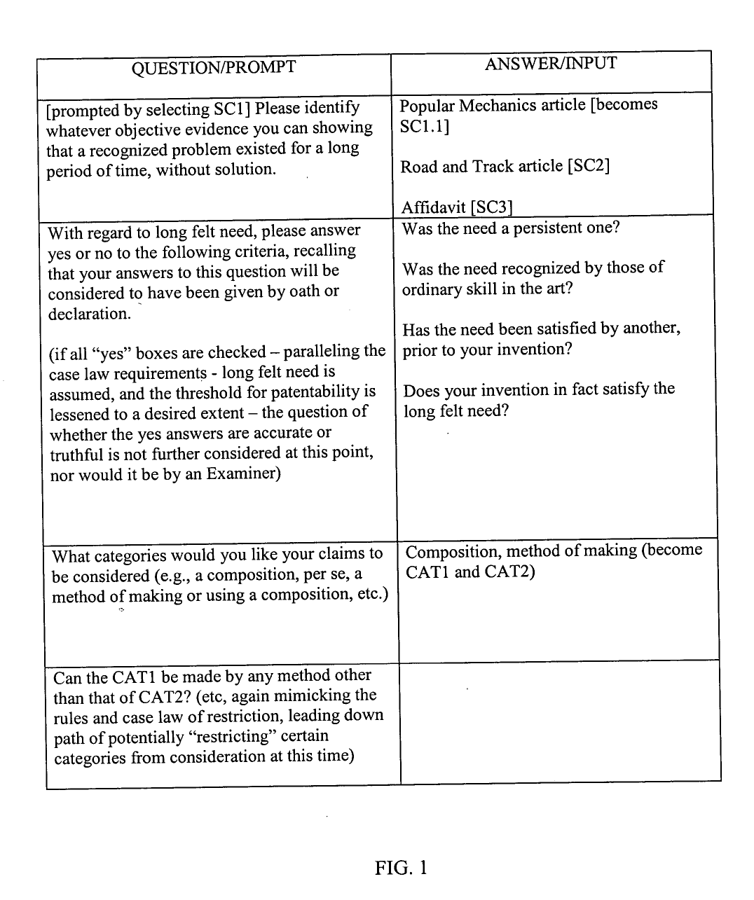

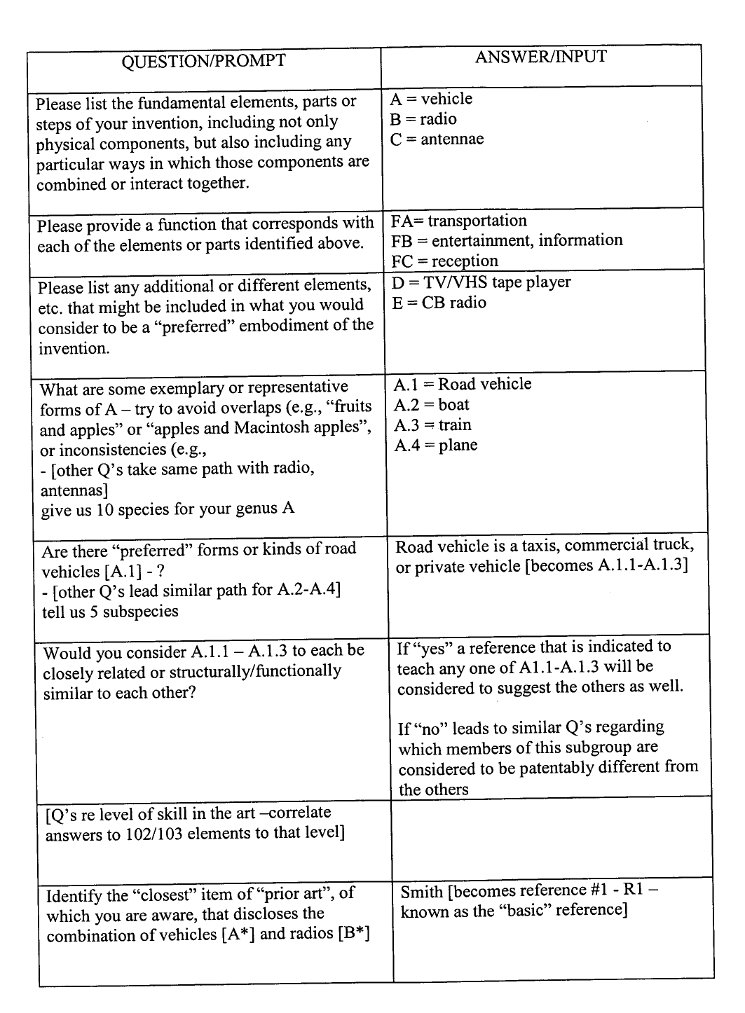

FIG. 1 provides an example of a questionnaire for use in eliciting input from an applicant regarding, among other things, both the invention and the cited art. It can be seen that the questions can be scalable, in that they can contemplate any number of elements, and are malleable, in that that the answer to one question can prompt a call for clarification or lead to a next question.

The questionnaire serves to prompt the applicant to provide various forms of input, including:

a) to methodically categorize the various elements of the invention, e.g., parts of a combination, steps of a method (e.g., into A.*.*.*, where an asterisk is used to refer to any suitable genus, species or subspecies, such as genera A.1 and A.2, species A.1.1, A.1.2, subspecies A.1.1.1, A.1.1.2, and so on.

b) to assert the manner or extent to which any particular elements “teach or suggest” others (e.g., whether a species can be considered as patentably equivalent to another species, a subspecies, or the genus, or instead, whether the applicant is prepared to assert that one is patentably distinct from another—common concepts within the patent law, though never employed in an automated fashion such as this.

c) to assert the extent to which each reference (R1-R5), individually teaches or suggests each of the various elements.

d) to assert the extent to which each reference is capable of being combined (within conventional rules) with those of the others.

Base on the input derived the system of this invention can generate comparison of various relationships as below, where:
A* to B*—steps, elements to other steps, elements
A* to A**—genus to species, or species to species, of steps, elements
A*, B* etc. to R1, R2, etc—steps, elements to teachings of references
R1 to R2—combinability of references to each other
R* to I—combinability of references with the field of the invention

e) to answer and unilaterally affirm any or all other questions that may be considered necessary, e.g., with regard to enablement, best mode, how to make and how to use requirements, etc., typically by asking them to identify particular portions of the specification that they intend to rely on with respect to each.

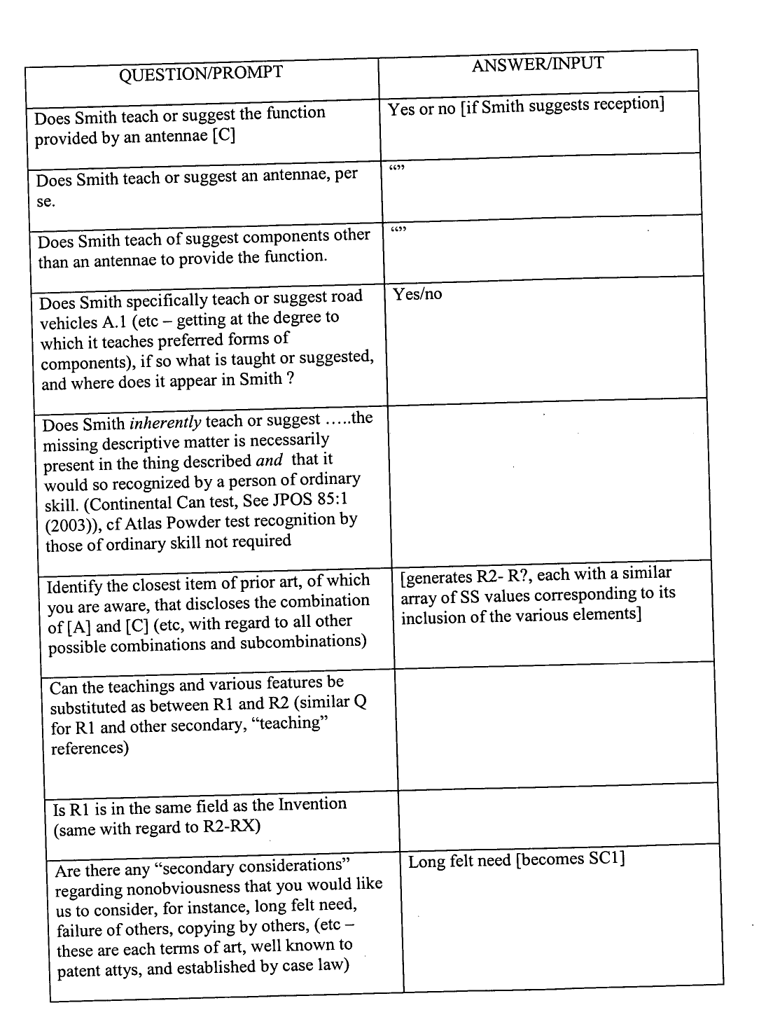

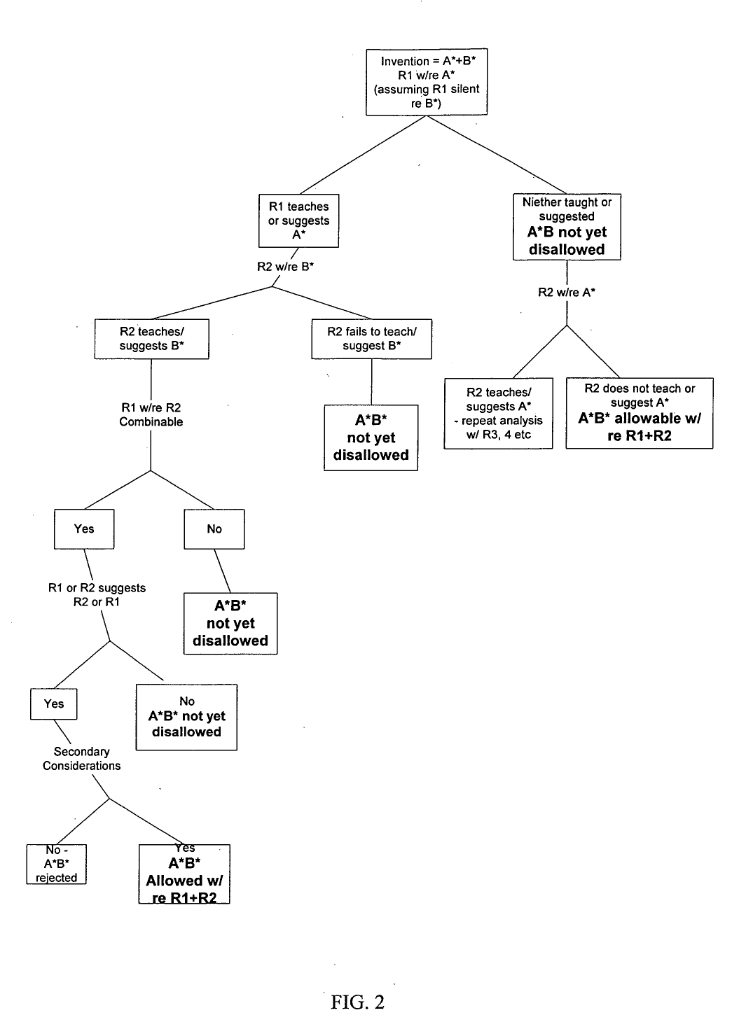

FIG. 2 provides an example of a decision tree intended to mimic a suitable, objective examination, based on input such as that provided in response to the questionnaire. The decision is similarly scalable to accommodate any desired number of elements and combinations of elements, as well as to accommodate differences between local customs or jurisdictions, as well as changes in related laws or rules.

The rules, documentation and actual software supporting and providing a preferred system are capable of being stored and archived, as in versions, in order to permit the version that was actually used to review or grant a particular patent to be recovered and reused to review that patent at a later date. This is particularly important in the world of patents, where the validity of a patent is generally determined based on the laws and rules in existence on the date it was issued, rather than based on those laws or rules as they may evolve and exist at the time of review or challenge.

1. A method for reviewing a patent application disclosing an invention in order to determine the extent to which the application meets some or all of the requirements for patentability, in view of one or more cited prior art references, the method comprising the steps of:
a) eliciting input regarding the invention, in order to establish one or more elements of the invention described in the application and the relationship between those elements and each other, combinations of such elements, and/or the cited art,
b) analyzing the elicited input in a semi- or fully automated fashion in order to determine whether one or more claims of the application, comprising one or more of its elements, meets predetermined standards for patentability.

2. A method according to claim 1 wherein some or all of the input is provided by the applicant.

3. A method according to claim 1 wherein some or all of the input is provided in response to a questionnaire.

4. A method according to claim 1 wherein the input is elicited in order to establish some or all of the elements in a hierarchal relationship with respect to each other.

5. A method according to claim 4 wherein the hierarchal relationship comprises a genus-species-subspecies relationship for one or more elements.

6. A method according to claim 1 wherein the elicited input is analyzed using artificial intelligence.

7. A method according to claim 1 wherein the elicited input is analyzed by applying it to one or more decision trees.

8. A method according to claim 1 wherein the input includes the identity of one or more cited art references, and the relationships between one or more elements or combination of elements of the invention and the teachings of the cited art and/or between the teachings of the references themselves.

9. A method according to claim 9 wherein the relationships include an affirmation regarding the extent to which the applicant considers a genus, species, and/or subspecies of a described element or combination of elements to be patentably distinct from each other, and/or from the genus, species, and/or subspecies of another element or combination of elements, and/or from the teachings of the cited art.

10. A method for reviewing a patent application in order to determine the extent to which the application meets some or all of the requirements for patentability in view of cited art, the method comprising the steps of:
a) eliciting input regarding the application, in order to establish one or more elements of the invention described in the application and the relationship between those elements and each other and/or the cited art,
b) analyzing the elicited input in an automated fashion in order to determine whether one or more claims of the application, comprising one or more of its elements, meets predetermined standards for patentability,
wherein the input is provided by the applicant in response to a questionnaire that establishes a hierarchal genus-species-subspecies relationship for one or more elements, and
wherein the input includes the identity of one or more cited art references, and the relationships between one or more elements or combinations of elements of the invention and the teachings of the cited art and/or between the teachings of the references themselves, and
wherein the relationships include an affirmation regarding the extent to which the applicant considers a genus, species, and/or subspecies of a described element or combination of elements to be patentably distinct from each other, and/or from the genus, species, and/or subspecies of another element or combination of elements, and/or from the teachings of the cited art.

11. A method according to claim 10 wherein the method is adapted to be modified in accordance with jurisdictional differences regarding patentability.

12. A method according to claim 10 wherein the method further comprises eliciting input to assess the manner and/or extent to which the application complies with one or more other requirements, selected from the group consisting of those commonly known as best mode, written description, and enablement.

13. A method according to claim 10 wherein the method is adapted for use as a training tool, as a prescreen for applications, or as a system for granting patents in its own right.

14. A method according to claim 10 wherein the elicited input is analyzed by applying it to one or more decision trees.

15. A method according to claim 10 wherein a) the method is adapted to be modified in accordance with jurisdictional differences regarding patentability, and b) the method further comprises the step of eliciting input to assess the manner and/or extent to which the application complies with one or more other requirements, selected from the group consisting of best mode, written description, enablement, and c) the method is adapted for use as a training tool, as a prescreen for applications, or as a system or component of a system for granting patents in its own right, and d) the elicited input is analyzed by applying it to one or more decision trees.

16. A method according to claim 15 wherein the method can be performed by accessing a site made available on the internet.

17. A system for performing the method of claim 1, the system comprising automated means for eliciting and analyzing the input.

18. A patent or prescreened application obtained as a result of the performing the method of claim 1.

19. A method of analyzing a granted patent in order to assess its validity, the method comprising applying a method according to claim 1 to the granted patent.

20. A method according to claim 19, wherein the granted patent is itself one that was granted using the method of claim 1, and the method of assessing its validity comprises the step of repeating the analysis, changing one or input parameters, in order to assess the impact of such change on patentability.
